(19) United States
(12) Patent Application Publication
(10) Pub. No.: US 2011/0119296 A1
(43) Pub. Date: May 19, 2011

(54) METHOD AND APPARATUS FOR DISPLAYING DATA

(75) Inventors: Soo-hong PARK, Yongin-si (KR); Ju-yun SUNG, Yongin-si (KR); Kil-su EO, Yongin-si (KR); Hwa-kyung LEE, Seoul (KR); Sung-bin IM, Yongin-si (KR); Jin-guk JEONG, Yongin-si (KR)

(73) Assignee: SAMSUNG ELECTRONICS CO., LTD., Suwon-si (KR)

(21) Appl. No.: 12/945,131

(22) Filed: Nov. 12, 2010

(30) Foreign Application Priority Data
Nov. 13, 2009 (KR) 10-2009-0109964

(51) Int. Cl. G06F 17/30

(52) U.S. Cl. 707/769; 707/E17.014

(57) ABSTRACT

A method of displaying data including searching for target content that matches information indicated by a first coordinate on a first coordinate axis and information indicated by a second coordinate on a second coordinate axis, and displaying the target content at a position corresponding to the first coordinate and the second coordinate.

### CROSS-REFERENCE TO RELATED PATENT APPLICATION

This application claims priority from Korean Patent Application No. 10-2009-0109964, filed Nov. 13, 2009, in the Korean Intellectual Property Office, the disclosure of which is incorporated herein in its entirety by reference.

### BACKGROUND

1. Field

Apparatuses and methods consistent with exemplary embodiments relate to a method and apparatus for displaying data, and more particularly, to a method and apparatus for displaying discovered data.

2. Description of the Related Art

Internet web browsers allow users to search for and access a website on the Internet, and to check web pages provided by the accessed website.

Many search engines are embodied on the websites, and users search for desired contents by inputting keywords into a certain field provided in a web page provided by the website.

In the related art, when a user searches for content items by inputting a keyword, the relationship between the discovered and displayed content items cannot be visually checked. Thus, the user may experience an inconvenience of checking the relationship between the displayed content items by checking the discovered content items one by one individually.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

Exemplary embodiments provide a method and apparatus for effectively displaying data by arranging found data so as to correspond to coordinate axes of N dimensions.

According to an aspect of an exemplary embodiment, there is provided a method of displaying data includes searching for target content that matches information indicated by a first coordinate on a first coordinate axis and information indicated by a second coordinate on a second coordinate axis; and displaying the target content at positions corresponding to the first coordinate and the second coordinate.

The searching may include determining a search keyword; first searching for at least one content related to the search keyword; and second searching for the target content in the at least one content.

The second searching may include obtaining metadata regarding the at least one content; and searching for the target content, based on the metadata.

The metadata may include at least one piece of information regarding a point of time that the content was manufactured, a location where the content was manufactured, a profile of a user who manufactured the content, a theme of the content, and an object included in the content.

The displaying may include displaying a recommendation keyword related to the target content along a third coordinate axis from the positions corresponding to the first coordinate and the second coordinate.

The method may further include setting a type of the target content, wherein the searching may include determining the target content, based on the set type.

The searching may include determining the target content, based on content preference information, if a number of contents that match the information indicated by the first coordinate and the information indicated by the second coordinate is at least two.

The displaying may include displaying contents that match the information indicated by the second coordinate along the first coordinate axis from the positions corresponding to the first coordinate and the second coordinate.

The displaying may include displaying contents that match the information indicated by the first coordinate along the second coordinate axis from the positions corresponding to the first coordinate and the second coordinate.

The first coordinate may indicate time information, and the second coordinate may indicate position information.

According to an aspect of another exemplary embodiment, there is provided an apparatus for displaying data on a screen includes a displaying unit for displaying the data; a searching unit for searching for target content that matches information indicated by a first coordinate on a first coordinate axis and information indicated by a second coordinate on a second coordinate axis; and a controller for controlling the displaying unit so as to display the target content at positions corresponding to the first coordinate and the second coordinate.

### BRIEF DESCRIPTION OF THE DRAWINGS

The above and/or other aspects will become more apparent by describing in certain exemplary embodiments, with reference to the accompanying drawings, in which:

FIG. 1 is a block diagram of a data displaying apparatus according to an exemplary embodiment;

FIG. 2 is a diagram illustrating discovered contents displayed along a time axis, according to an exemplary embodiment;

FIG. 3 is a diagram illustrating discovered contents displayed along a time axis, according to an exemplary embodiment;

FIG. 4 is a diagram illustrating discovered contents displayed along a time axis and a space axis, according to an exemplary embodiment;

FIG. 5 is a diagram illustrating discovered contents displayed along a time axis and an object axis, according to an exemplary embodiment;

FIG. 6 is a diagram illustrating discovered contents displayed along a time axis, an object axis and an emotion axis, according to an exemplary embodiment;

FIG. 7 is a diagram illustrating discovered contents displayed along two axes for indicating a point of time, according to an exemplary embodiment;

FIG. 8 is a diagram illustrating information displayed on X, Y axes for indicating a point of time and an amount of hits, according to an exemplary embodiment;

FIG. 9 is a diagram illustrating discovered contents displayed along a time axis and a space axis, according to another exemplary embodiment;

FIG. 10 is a diagram of a method of displaying data, according to an exemplary embodiment;

FIG. 11 is a flowchart of a method of generating metadata, according to an exemplary embodiment;

FIG. 12 is a flowchart of a method of processing metadata, according to an exemplary embodiment;

FIG. 13 is a block diagram of a data displaying apparatus, according to another exemplary embodiment; and

FIG. 14 is a flowchart of a method of displaying data, according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters.

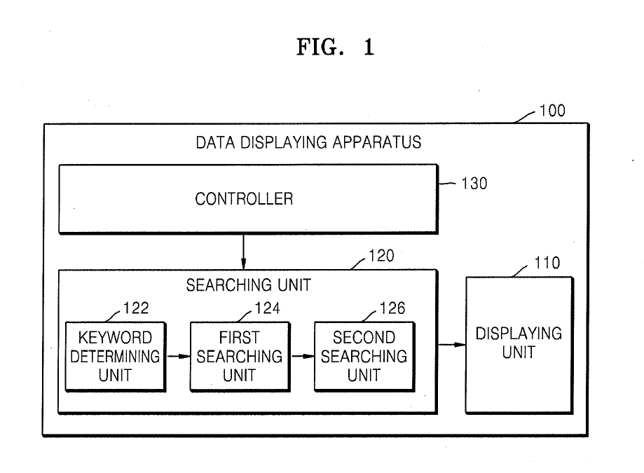

FIG. 1 is a block diagram of a data displaying apparatus 100 according to an exemplary embodiment.

The data displaying apparatus 100 includes a displaying unit 110, a searching unit 120, and a controller 130.

Data is displayed on the displaying unit 110. A first coordinate axis and a second coordinate axis, which are described in greater detail below, may be displayed on the displaying unit 110, and content may be arranged along the first coordinate axis and the second coordinate axis. Alternatively, only the content may be arranged along the first coordinate axis and the second coordinate axis, and the first coordinate axis and the second coordinate axis are not displayed on the displaying unit 110.

The searching unit 120 searches for content which matches information indicated by a first coordinate on the first coordinate axis and information indicated by a second coordinate on the second coordinate axis. The content which matches the information indicated by the first coordinate and the information indicated by the second coordinate is referred to as target content of a relevant coordinate.

The information indicated by the first coordinate and the information indicated by the second coordinate may vary, according to exemplary embodiments. For example, at least one of the first coordinate and the second coordinate may indicate information regarding a point of time when content is generated, a point of time related to an object included in the content, information regarding a location where the content is generated, or a location related to the object included in the content. In addition, at least one of the first coordinate and the second coordinate may indicate user related information, emotional information, etc.

For example, when the first coordinate indicates time information as the year 2006, and the second coordinate indicates location information of 135 degrees of longitude east, and 38.5 degrees of latitude north, the searching unit 120 may search for content related to an object located at approximately 135 degrees of longitude east, and approximately 38.5 degrees of latitude north in 2006.

The searching unit 120 includes a keyword determining unit 122, a first searching unit 124, and a second searching unit 126.

The keyword determining unit 122 determines a search keyword. The keyword may be supplied by a user inputting the search keyword, or a user selecting content displayed on the displaying unit 110.

The first searching unit 124 searches for content related to the search keyword. The first searching unit 124 may search for content related to the search keyword using a search engine on the Internet, or may search for content related to the keyword in an internal database.

The second searching unit 126 may search for content which matches the information indicated by the first coordinate and the information indicated by the second coordinate, based on the search keywords. The second searching unit 126 may obtain metadata regarding content searched for by the first searching unit 124. The second searching unit 126 may extract the metadata from the content, or may request an external server to transmit the metadata. The metadata may include at least one piece of information regarding a point of time when the content is generated, a location where the content is generated, a profile of a user who generated the content, a theme of the content, and an object included in the content. For example, the content may be an image of the Sungsoo Grand Bridge. In this case, the metadata may include information regarding a point of time when the image was captured, a location where the image was captured, a profile of a photographer, the name of the Sungsoo Grand Bridge, etc.

The second searching unit 126 may select the content which matches the information indicated by the first coordinate and the information indicated by the second coordinate, according to the metadata of the content.

A plurality of content items may match the information indicated by the first coordinate and the information indicated by the second coordinate.

For example, the first coordinate may indicate the year 1994, the second coordinate may indicate location information 1 km north, and the search keyword may be the ‘Sungsoo Grand Bridge’. The first searching unit 124 may search for relevant content items by inputting the Sungsoo Grand Bridge as the search keyword. The second searching unit 126 may search for content items that match 1994 and a location approximately 1 km north from the content items identified by the first searching unit 124. As a search result, an image of the Banpo Grand Bridge in 1994 and articles regarding the Banpo Grand Bridge in 1994 may be located.

The second searching unit 126 may determine the target content according to information of a type of the content.

When the type of target content is set to be an image, the second searching unit 126 determines the image of the Banpo Grand Bridge in 1994 as the target content. When the type of the target content is set to be an article, the second searching unit 126 determines the articles regarding the Banpo Grand Bridge in 1994 as the target content.

In addition, the second searching unit 126 may determine the target content according to the information regarding content preference.

If users of a similar user group click the image of the Banpo Grand Bridge in 1994 more times than the articles regarding the Banpo Grand Bridge in 1994, the second searching unit 126 may determine the image of the Banpo Grand Bridge in 1994 as the target content.

The controller 130 controls the displaying unit 110 to display the target content at positions corresponding to the first coordinate and the second coordinate. In addition, the controller 130 may control the displaying unit 110 to display content items that match the information indicated by the second coordinate, along the first coordinate axis, and content items that match the information indicated by the first coordinate, along the second coordinate axis, in the positions corresponding to the second coordinate and the first coordinate, respectively.

For example, the information indicated by the first coordinate is the year 1994, the information indicated by the second coordinate is 1 km north, and the keyword is the Sungsoo Grand Bridge. Content items that match 1994 from content items related to the Sungsoo Grand Bridge may be arranged along the second coordinate axis, and contents that match a location approximately 1 km north from the content items related to the Sungsoo Grand Bridge may be arranged along the first coordinate axis, in the positions corresponding to the second coordinate and the first coordinate, respectively.

The controller 130 may control the displaying unit 110 to display a recommendation keyword related to the target content along a third coordinate axis in the positions corresponding to the first coordinate and the second coordinate. If the target content is the image of the Banpo Grand Bridge in 1994, the controller 130 may display the Banpo Grand Bridge as the recommendation keyword on the third coordinate axis. If there are at least two recommendation keywords, the recommendation keywords are arranged so that the priority of the recommendation keyword may be increased towards the target content.

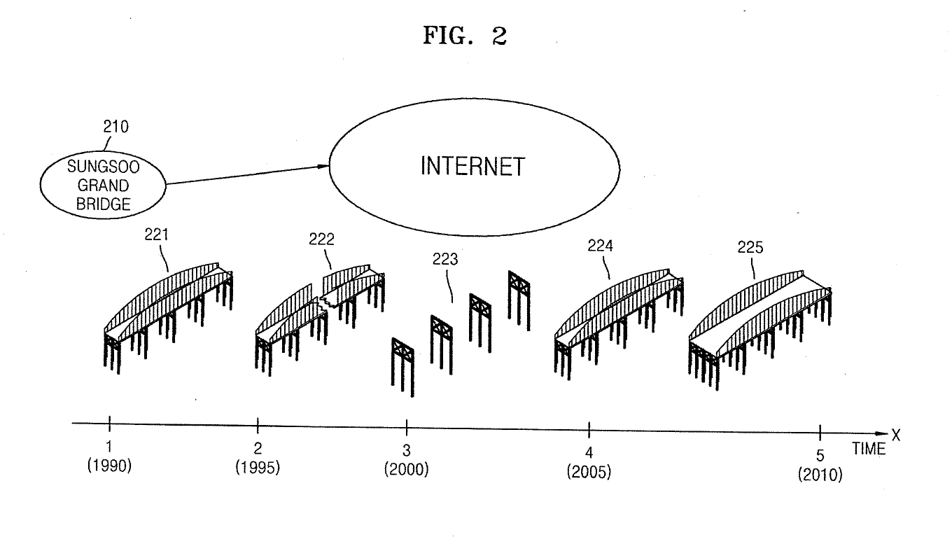

FIG. 2 is a diagram illustrating discovered content items displayed along a time axis by using the data displaying apparatus 100, according to an exemplary embodiment.

A user inputs the ‘Sungsoo Grand Bridge’ as a search keyword. The searching unit 120 searches for contents related to the Sungsoo Grand Bridge by using the search engine. For example, the searching unit 120 searches for image contents related to the Sungsoo Grand Bridge.

The searching unit 120 searches for and discovers an image 221 of Sungsoo Grand Bridge in 1990, an image 222 of Sungsoo Grand Bridge in 1995, an image 223 of Sungsoo Grand Bridge in 2000, an image 224 of Sungsoo Grand Bridge in 2005, and an image 225 of Sungsoo Grand Bridge in 2005.

In FIG. 2, the x-axis is the first coordinate axis for indicating a time sequence, and indicates years. In detail, the x coordinate ‘1’ indicates the year 1990, the x coordinate ‘2’ indicates the year 1995, the x coordinate ‘3’ indicates the year 2000, the x coordinate ‘4’ indicates the year 2005, and the x coordinate ‘5’ indicates the year 2010. The searching unit 120 arranges the found images on coordinates corresponding thereto.

In the related art, when a user searches for content items by inputting a keyword, the relationship between the found contents cannot be checked. Thus, the user may experience the inconvenience of checking the relationship by checking the discovered content items one by one.

However, according to an exemplary embodiment, the data displaying apparatus 100 may analyze and visually display the discovered contents according to predetermined criteria such as time or location, and thus the user may intuitively obtain information.

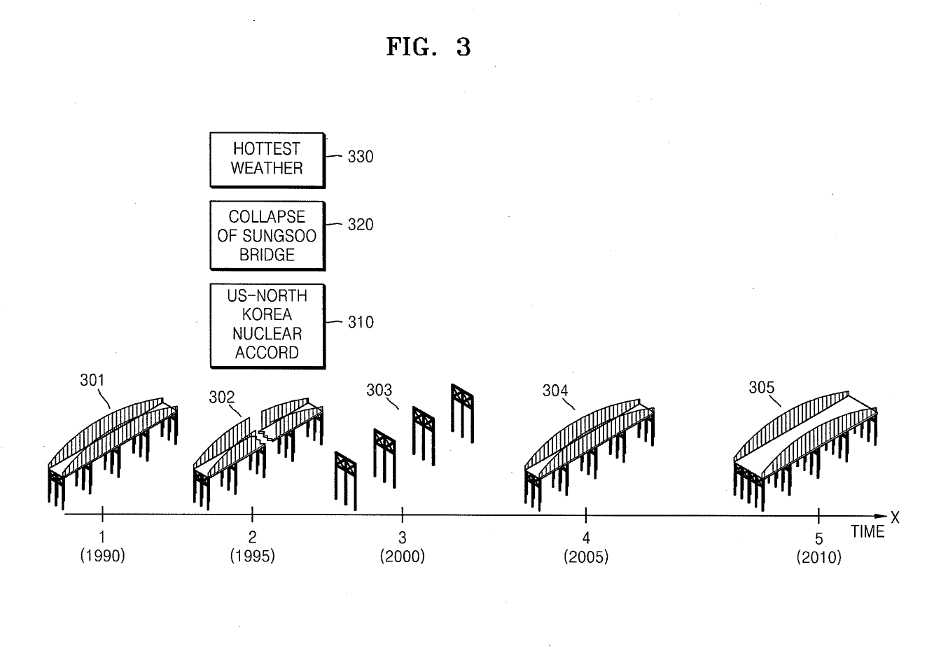

FIG. 3 is a diagram illustrating discovered contents displayed along a time axis by using the data displaying apparatus 100, according to an exemplary embodiment.

In FIG. 3, the x-axis is the first coordinate axis for indicating a time sequence, and indicates years. In detail, the x coordinate ‘1’ indicates the year 1990, the x coordinate ‘2’ indicates the year 1995, the x coordinate ‘3’ indicates the year 2000, the x coordinate ‘4’ indicates the year 2005, and the x coordinate ‘5’ indicates the year 2010.

For example, a user selects the year 1995. The searching unit 120 searches for contents that match the year 1995 that is information indicated by the first coordinate on the first coordinate axis. In FIG. 3, an article 310 related to US-North Korea nuclear accord, an article 320 related to the collapse of Sungsoo Bridge, and an article 330 related to hottest weather are discovered as a result of the search. The discovered articles 310, 320, 330 are sequentially arranged at positions to correspond to the year 1995. The order in which the content items are arranged may be set according to a preference, the number of recommendations, a type, etc.

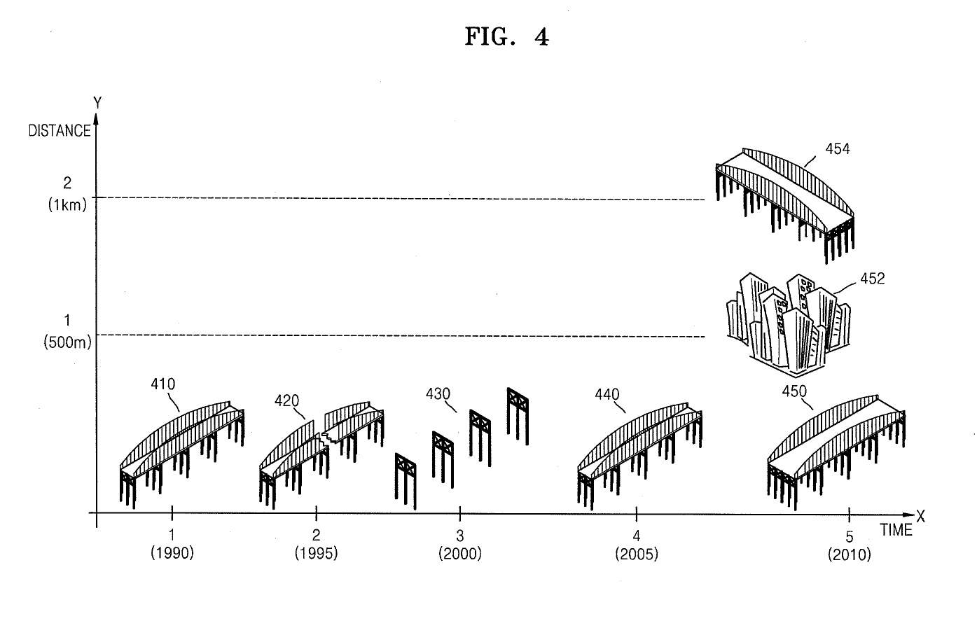

FIG. 4 is a diagram illustrating discovered contents displayed along a time axis and a space axis by using the data displaying apparatus 100, according to an exemplary embodiment.

In the FIG. 4, the x-axis is the first coordinate axis for indicating a time sequence, and indicates years. In detail, the x coordinate ‘1’ indicates the year 1990, the x coordinate ‘2’ indicates the year 1995, the x coordinate ‘3’ indicates the year 2000, the x coordinate ‘4’ indicates the year 2005, and the x coordinate ‘5’ indicates the year 2010.

The y-axis is the second coordinate axis for indicating a geographical location, and is used to indicate the direction and distance from the Sungsoo Grand Bridge. In detail, the y coordinate ‘1’ corresponds to the location which is approximately 500 m north of the Sungsoo Grand Bridge. The y coordinate ‘2’ corresponds to the location which is approximately 1000 m north of the Sungsoo Grand Bridge. Likewise, the y coordinate ‘−1’ corresponds to the location which is approximately 500 m south of the Sungsoo Grand Bridge (not shown). And the y coordinate ‘−2’ corresponds to the location which is approximately 1000 m south of the Sungsoo Grand Bridge (not shown).

The searching unit 120 searches for and discovers an image 410 of Sungsoo Grand Bridge in 1990, an image 420 of Sungsoo Grand Bridge in 1995, an image 430 of Sungsoo Grand Bridge in 2000, an image 440 of Sungsoo Grand Bridge in 2005, and an image 450 of Sungsoo Grand Bridge in 2010, and arranges the images 410, 420, 430, 440, and 450 at coordinates corresponding thereto. For example, the user selects the image 450 of Sungsoo Grand Bridge in 2010.

The searching unit 120 searches for target content corresponding to a coordinate (5, 1). The coordinate (5, 1) indicates time information of the year 2010 and location information of 500 m north of the Sungsoo Grand Bridge. The searching unit 120 discovers for an image 452 image of an apartment building located approximately 500 m north of the Sungsoo Grand Bridge in 2010.

The searching unit 120 searches for target content corresponding to a coordinate (5, 2). The coordinate (5, 2) indicates time information of the year 2010 and location information of 1000 m north of the Sungsoo Grand Bridge. The searching unit 120 searches for and discovers an image 454 of a bridge located approximately 1000 m north of the Sungsoo Grand Bridge in 2010.

Accordingly, the discovered images 452, 454 are displayed at a position corresponding to the year 2010.

In FIG. 4, only content items that are arranged in positions having the same x coordinate or the same y coordinate as coordinates selected by the user are displayed on the displaying unit 110. Alternatively, all content items found by the second searching unit 126 may be displayed on the displaying unit 110, and the content items corresponding to the same x coordinate and y coordinate as the coordinates selected by the user may be highlighted.

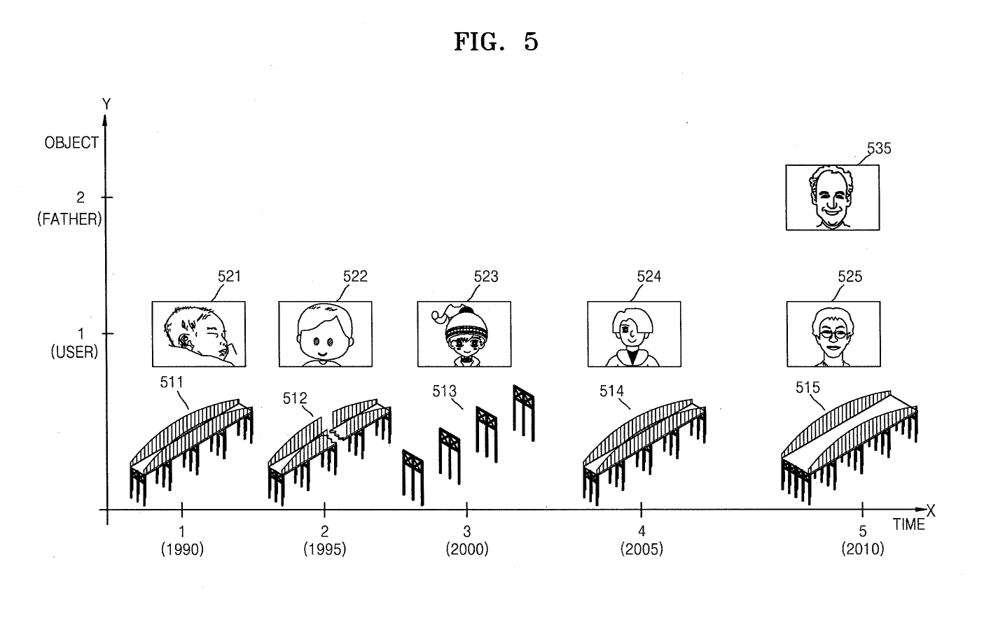

FIG. 5 is a diagram illustrating discovered contents displayed along a time axis and an object axis by using the data displaying apparatus 100, according to an exemplary embodiment.

In FIG. 5, the x-axis is the first coordinate axis for indicating a time sequence, and indicates years. In detail, the x coordinate ‘1’ indicates the year 1990, the x coordinate ‘2’ indicates the year 1995, the x coordinate ‘3’ indicates the year 2000, the x coordinate ‘4’ indicates the year 2005, and the x coordinate ‘5’ indicates the year 2010.

The y-axis is the second coordinate axis for indicating a relationship with a user. In detail, the y coordinate ‘1’ corresponds to the user. And the y coordinate ‘2’ corresponds to a user's father.

The searching unit 120 searches for and discovers an image 511 of Sungsoo Grand Bridge in 1990, an image 512 of Sungsoo Grand Bridge in 1995, an image 513 of Sungsoo Grand Bridge in 2000, an image 514 of Sungsoo Grand Bridge in 2005, and an image 515 of Sungsoo Grand Bridge in 2010, and arranges the images 511, 512, 513, 514, and 515 at coordinates corresponding thereto.

The searching unit 120 searches for and discovers an image 521 of user of 1990, an image 522 of user of 1995, an image 523 of user of 2000, an image 524 of user of 2005, and an image 525 of user of 2010, and arranges the images 521, 522, 523, 524, and 525 at coordinates corresponding thereto.

The searching unit 120 searches for target content corresponding to a coordinate (5, 2). The coordinate (5, 2) indicates time information of the year 2010 and relationship information of user's father. The searching unit 120 searches for and discovers an image 535 of the father in 2010, and arranges the image 535 of the father in 2010 at a coordinate (5, 2).

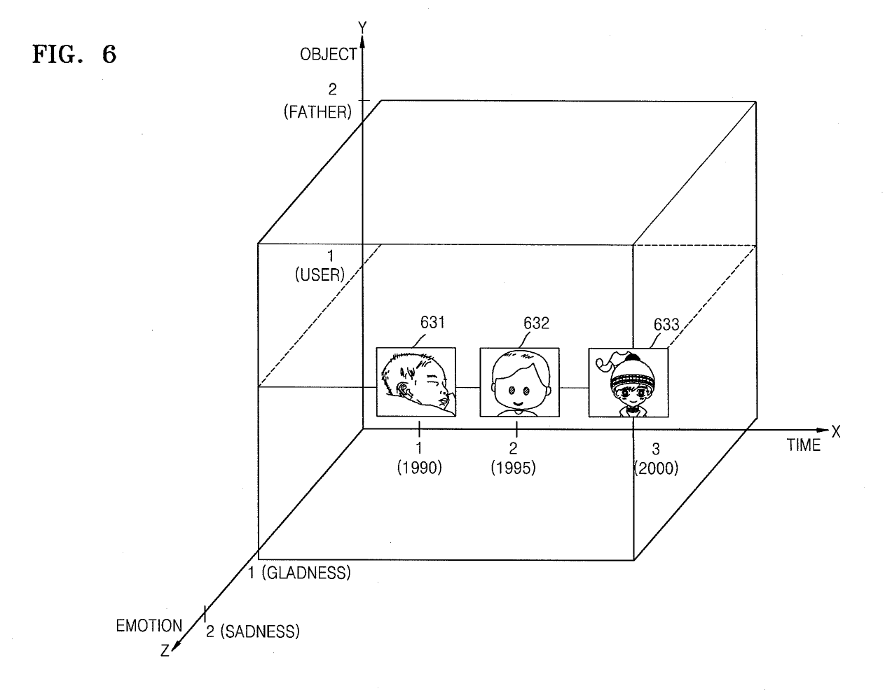

FIG. 6 is a diagram illustrating discovered contents displayed along a time axis, an object axis, and an emotion axis by using the data displaying apparatus 100, according to an exemplary embodiment.

In FIG. 6, the x-axis is the first coordinate axis for indicating a time sequence, and indicates years. In detail, the x coordinate ‘1’ indicates the year 1990, the x coordinate ‘2’ indicates the year 1995, and the x coordinate ‘3’ indicates the year 2000.

The y-axis is the second coordinate axis for indicating a relationship with a user. In detail, the y coordinate ‘1’ corresponds to the user. And the y coordinate ‘2’ corresponds to a user's father.

The z-axis is a third coordinate axis for indicating emotional states. In detail, the z coordinate ‘1’ corresponds to gladness. And the z coordinate ‘2’ corresponds to sadness.

For example, the user selects a coordinate (0, 1, 1).

The searching unit 120 searches for target content corresponding to the coordinate (1, 1, 1). The coordinate (1, 1, 1) indicates the year 1990, relationship information of the user, and emotional information of gladness. The searching unit 120 searches for and discovers an image content 631 that matches 1990, user, and gladness, and arranges the image content 631 at (1, 1, 1). Images are arranged at coordinates corresponding thereto. Similarly, the searching unit 120 searches for and discovers image content 632 that matches 1995, user, and gladness, and arranges the image content 632 at (2, 1, 1). In addition, the searching unit 120 searches for and discovers image content 633 that matches 2000, user, and gladness, and arranges the image content 633 at (3, 1, 1).

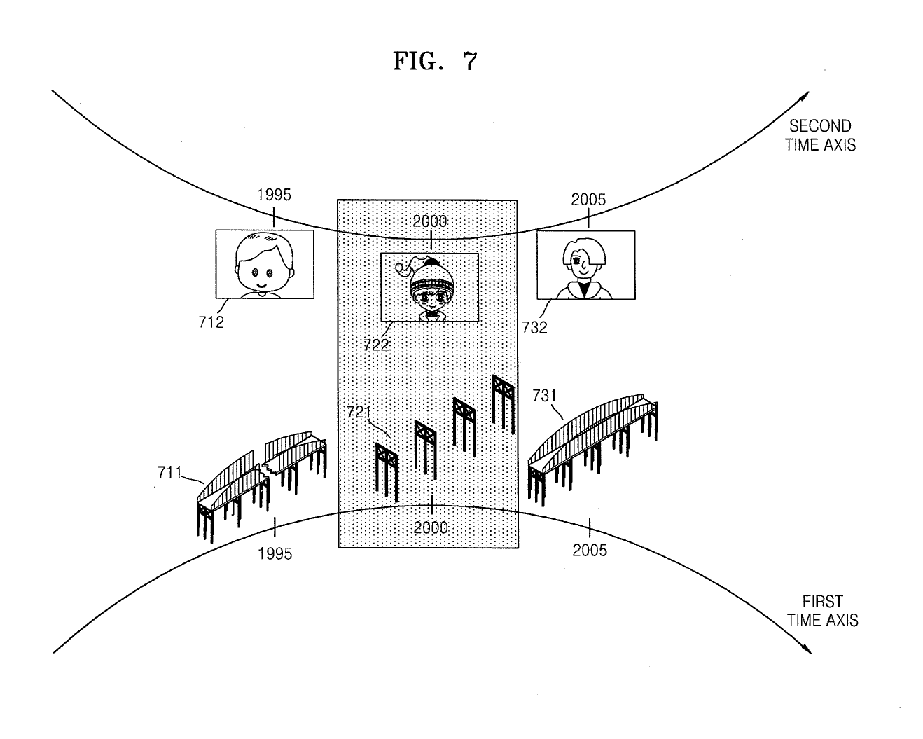

FIG. 7 is a diagram illustrating discovered contents displayed along two axes for indicating a point of time by using the data displaying apparatus 100, according to an exemplary embodiment.

Image content items related to the Sungsoo Grand Bridge are arranged on the first coordinate axis in a time sequence. That is, an image 711 of Sungsoo Grand Bridge in 1995, an image 721 of Sungsoo Grand Bridge in 2000, and an image 731 of Sungsoo Grand Bridge in 2005 are sequentially arranged along the first coordinate axis. Image content items related to the user are arranged on the second coordinate axis in a time sequence. That is, an image 712 of user in 1995, an image 722 of user in 2000, and an image 732 of user in 2005 are sequentially arranged along the second coordinate axis.

For example, the user selects the year 2000. Thus, the image 721 of Sungsoo Grand Bridge in 2000 and the image 722 of the user in 2000 are highlighted.

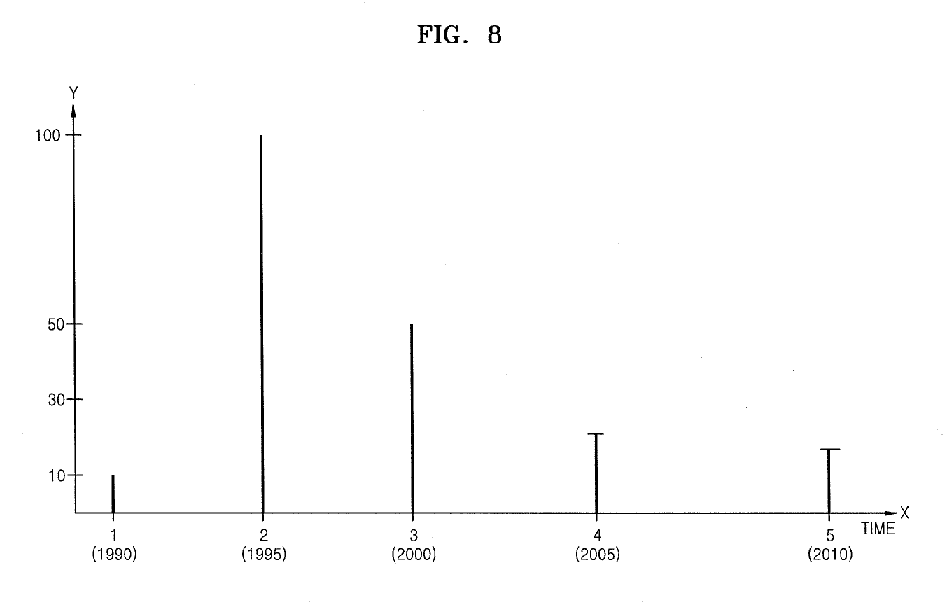

FIG. 8 is a diagram illustrating information displayed on X and Y axes for indicating a point of time and an amount of hits by using the data displaying apparatus 100, according to an exemplary embodiment.

The searching unit 120 searches for and discovers content items by using the Sungsoo Grand Bridge as a search keyword. The searching unit 120 may calculate distribution of the content items according to the year.

For example, a number of content items that match the year 1990 is 10, a number of content items that match the year 1995 is 100, and a number of content items that match the year 2000 is 50. Content items that match the year 2005 and the year 2010 are each 30.

For example, the user may observe that the number of content items that match the year 1995 is the greatest. Accordingly, based on the information displayed on the displaying unit 110, the user may intuitively grasp the amount of the occurrences of the events for each respective year.

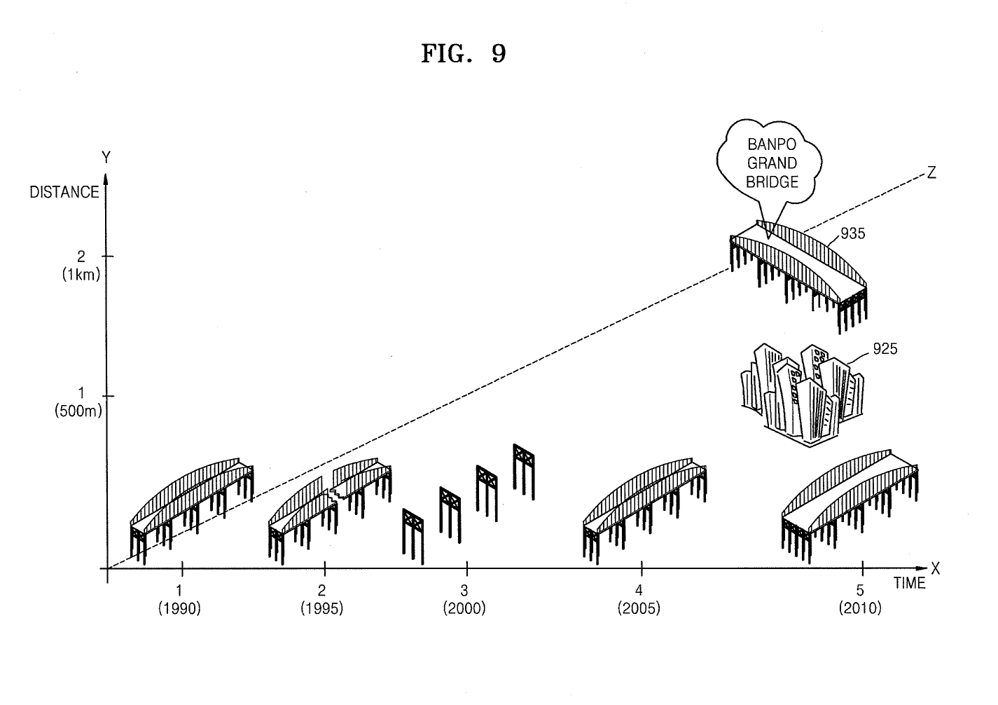

FIG. 9 is a diagram illustrating discovered contents displayed along a time axis and a space axis by using the data displaying apparatus 100, according to another exemplary embodiment.

The x-axis is the first coordinate axis for indicating a time sequence, and the y-axis is the second coordinate axis for indicating a geographic location.

In FIG. 9, the x coordinate indicates a year. In detail, the x coordinate ‘1’ indicates the year 1990, the x coordinate ‘2’ indicates the year 1995, the x coordinate ‘3’ indicates the year 2000, the x coordinate ‘4’ indicates the year 2005, and the x coordinate ‘5’ indicates the year 2010. The y coordinate ‘1’ corresponds to the location which is approximately 500 m north of the Sungsoo Grand Bridge. The y coordinate ‘2’ corresponds to the location which is approximately 1000 m north of the Sungsoo Grand Bridge. The y coordinate ‘−1’ corresponds to the location which is approximately 500 m south of the Sungsoo Grand Bridge. The y coordinate ‘−2’ corresponds to the location which is approximately 1000 m south of the Sungsoo Grand Bridge.

The searching unit 120 may search for image contents related to the Sungsoo Grand Bridge, and may arrange the image contents at coordinates corresponding thereto.

In detail, the searching unit 120 searches for target content corresponding to a coordinate (5, 1). The coordinate (5, 1) indicates time information of the year 2010 and location information of 500 m north of the Sungsoo Grand Bridge. The searching unit 120 searches for and discovers an image 925 of an apartment building located approximately 500 m north of the Sungsoo Grand Bridge in 2010, and arranges the image 925 of an apartment building located approximately 500 m north of the Sungsoo Grand Bridge in 2010 at the coordinate (5, 1).

In order to satisfy the user's requirements for more detailed information regarding the contents arranged in a coordinate space, the controller 130 may provide recommendation keywords related to the target contents in a third coordinate axis Z. The third coordinate axis Z may be orthogonal to the first coordinate axis X and the second coordinate axis Y.

In FIG. 9, the controller 130 may display an image 935 of the Banpo Grand Bridge as the recommendation keyword along the third coordinate axis at a position corresponding to the coordinate (5, 2). Thus, the recommendation keyword is displayed at the coordinate (5, 1, 2). The controller 130 may arrange the recommendation keywords so that the priority of the recommendation keyword may be increased towards a selected position.

The user may easily search for content by selecting a search keyword related to the content.

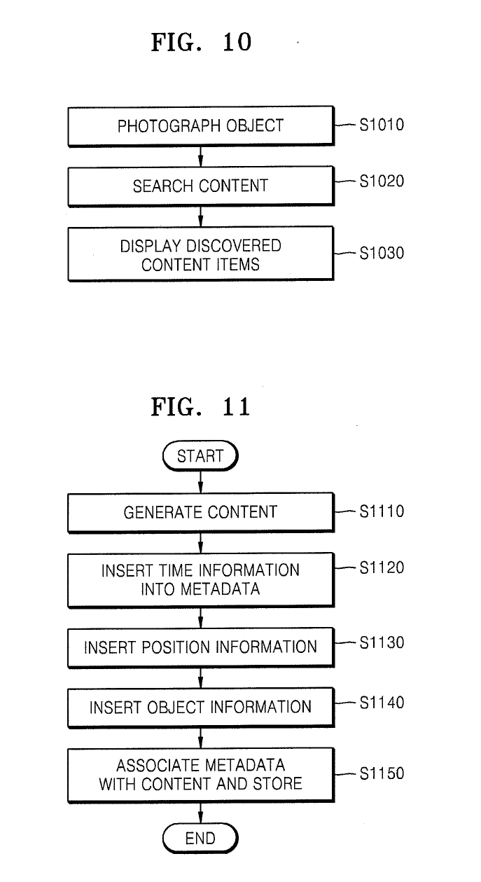

FIG. 10 is a diagram for explaining a method of displaying data on the data displaying apparatus 100, according to an exemplary embodiment.

In operation S1010, a user photographs an object by using a camera attached to the data displaying apparatus 100.

In operation S1020, contents related to the photographed object are searched for. In detail, information related to the object is extracted by analyzing image data. For example, object identification information, photographing point of time information, photographing location information, etc. may be extracted.

The contents related to the photographed object are searched for by using the extracted information. If the object is analyzed to be the Sungsoo Grand Bridge, contents related to the Sungsoo Grand Bridge are searched for by using the Sungsoo Grand Bridge as a keyword. Simultaneously, metadata regarding the analyzed contents may be obtained.

In operation S1030, the discovered contents are analyzed according to a first criteria, and are arranged along the first coordinate axis. In addition, the discovered contents are analyzed according to a second criteria, and are arranged along the second coordinate axis. For example, image contents of the Sungsoo Grand Bridge may be sequentially arranged on the x axis in a photographing time sequence. In addition, objects proximate to the Sungsoo Grand Bridge may be sequentially arranged on the y axis according to a distance from the Sungsoo Grand Bridge.

FIG. 11 is a flowchart of a method of generating metadata, according to an exemplary embodiment.

In operation S1110, content is generated.

In operation S1120, time information is inserted into the metadata regarding the content generation. The time information may be extracted from a timer information of a device for generating the content. The inserted time information may be a time when the content is generated, or a point of time related to an object included in the content. For example, when the content is generated by scanning an image corresponding to the year 1980 in the year 1990, the time information may contain the year 1980 related to the object and the year 1990 when the content is generated.

In operation S1130, position information regarding the content is inserted into the metadata. The position information may be obtained by a global positioning system (GPS) attached to a device for generating the content. The inserted position information may be a location where the content is generated and/or a position related to the location of the object included in the content.

In operation S1140, relationship information regarding the user or the object is inserted into the metadata regarding the content. The relationship information may be extracted from a text message or address book stored in a cellular phone, or may be input directly by the user.

In operation S1150, the content and the metadata are associated with one another and stored. The metadata may contain a basic region and an extension region. Generally, information contained in the metadata may be recorded in the basic region, and at least one of the time information, the location information, and the relationship information may be recorded in the extension region.

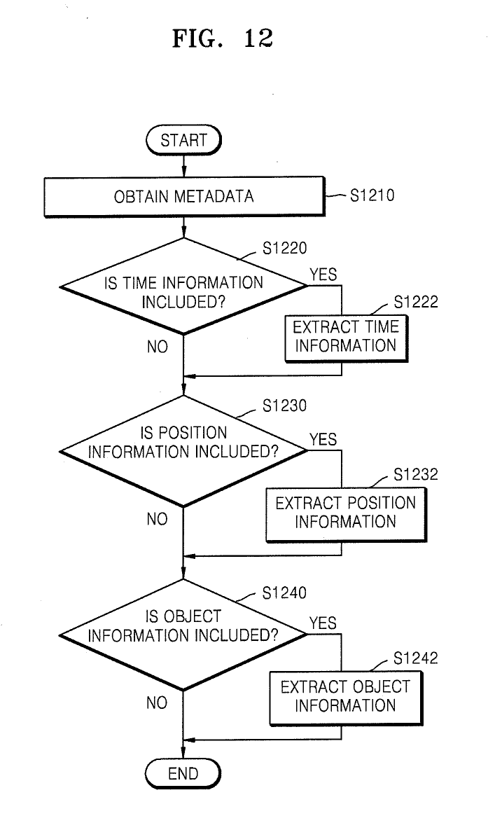

FIG. 12 is a flowchart of a method of processing metadata, according to an exemplary embodiment.

In operation S1210, the metadata regarding content is obtained.

In operation S1220, it is determined whether the time information is included in the metadata. The metadata may contain a flag for indicating whether the time information is included in the metadata. If the time information is included in the metadata, operation S1222 is performed to extract the time information. If the time information is not included in the metadata, operation S1230 is performed.

In operation S1230, it is determined whether the position information is included in the metadata. The metadata may contain a flag for indicating whether the position information is included in the metadata. If the position information is included in the metadata, operation S1232 is performed to extract the position information. If the position information is not included in the metadata, operation S1240 is performed. According to another exemplary embodiment, when the position information is not included in the metadata, the position information related to the content may be obtained through a website or a GPS.

In operation S1240, it is determined whether the object information is included in the metadata. The metadata may include a flag for indicating whether the object information is included in the metadata. If the object information is included in the metadata, operation S1242 is performed to extract the object information.

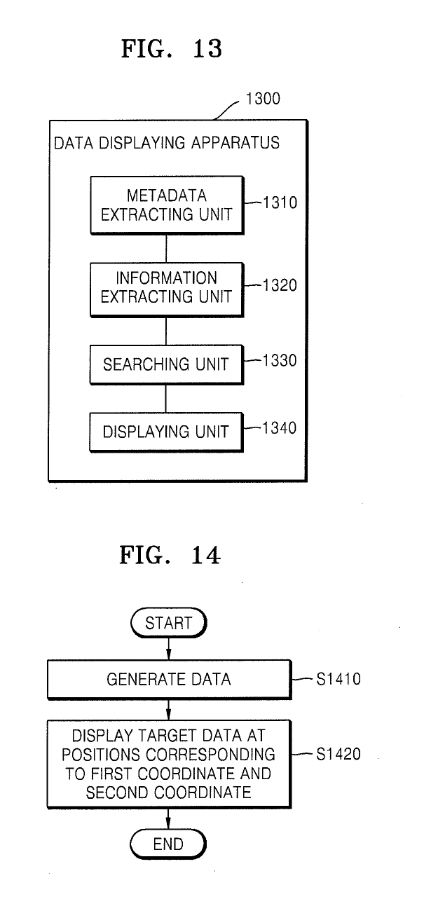

FIG. 13 is a block diagram of a data displaying apparatus 1300 according to another exemplary embodiment.

The data displaying apparatus 1300 includes a metadata extracting unit 1310, an information extracting unit 1320, a searching unit 1330, and a displaying unit 1340.

The metadata extracting unit 1310 obtains contents that are searched for by the search keywords or metadata regarding contents stored in a database. The metadata may be attached to the contents and may be stored, or may be received via a network.

The information extracting unit 1320 extracts information from the obtained metadata. The information may include at least one of the time information, the location information and the relationship information, which relate to the content or an object included in the content.

The searching unit 1330 searches for contents by using the extracted information. The searching unit 1330 may search for content that matches information indicated by a first coordinate and information indicated by a second coordinate.

The displaying unit 1340 may arrange and display the content by using the extracted information.

FIG. 14 is a flowchart of a method of displaying data according to an exemplary embodiment.

In operation S1410, target content that matches information indicated by a first coordinate on a first coordinate axis and information indicated by a second coordinate on a second coordinate axis is searched for and the data corresponding to the discovered target content is generated.

In operation S1420, the target content data is displayed at positions corresponding to the first coordinate and the second coordinate.

Exemplary embodiments can be implemented by computer programs and can be implemented in general use computers that execute the programs using a computer-readable recording medium. Examples of the computer-readable recording medium include magnetic storage media (e.g., ROM, floppy disks, hard disks, etc.), and storage media such as optical recording media (e.g., CD-ROMs, or DVDs).

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for displaying data, the method comprising:
searching for target content that matches information indicated by a first coordinate on a first coordinate axis and information indicated by a second coordinate on a second coordinate axis; and
displaying the target content at a position corresponding to the first coordinate and the second coordinate.

2. The method of claim 1, wherein the searching comprises:
receiving a search keyword;
first searching for at least one content item related to the search keyword; and
second searching for the target content corresponding to the at least one content item.

3. The method of claim 2, wherein the second searching comprises:
obtaining metadata regarding the at least one content item; and
searching for the target content, based on the metadata.

4. The method of claim 3, wherein the metadata comprises at least one piece of information regarding a point of time when the content item is generated, a location where the content item is generated, a profile of a user who generated the content item, a theme of the content item, and an object included in the content item.

5. The method of claim 1, wherein the displaying comprises displaying a recommendation keyword related to the target content along a third coordinate axis at the position corresponding to the first coordinate and the second coordinate.

6. The method of claim 1, further comprising setting a type of the target content, wherein the searching comprises determining the target content, based on the set type.

7. The method of claim 1, wherein the searching comprises determining the target content, based on content preference information, if a number of content items that matches the information indicated by the first coordinate and the information indicated by the second coordinate is at least two.

8. The method of claim 1, wherein the displaying comprises displaying content items that match the information indicated by the second coordinate along the first coordinate axis at positions corresponding to first coordinates.

9. The method of claim 1, wherein the displaying comprises displaying content items that match the information indicated by the first coordinate along the second coordinate axis at positions corresponding to second coordinates.

10. The method of claim 1, wherein the first coordinate indicates time information, and the second coordinate indicates position information.

11. An apparatus for displaying data, the apparatus comprising:
a searching unit which searches for target content that matches information indicated by a first coordinate on a first coordinate axis and information indicated by a second coordinate on a second coordinate axis; and
a controller which controls a displaying unit to display the target content at a position corresponding to the first coordinate and the second coordinate.

12. The apparatus of claim 11, wherein the searching unit comprises:
a keyword determining unit which determines a search keyword;
a first searching unit which searches for at least one content item related to the search keyword; and
a second searching unit which searches for the target content corresponding to the at least one content item.

13. The apparatus of claim 12, wherein the second searching unit obtains metadata regarding the at least one content item, and searches for the target content, based on the metadata.

14. The apparatus of claim 13, wherein the metadata comprises at least one piece of information regarding a point of time when the content item is generated, a location where the content item is generated, a profile of a user who generated the content item, a theme of the content item, and an object included in the content item.

15. The apparatus of claim 11, wherein the controller controls the displaying unit to display a recommendation keyword related to the target content along a third coordinate axis at the position corresponding to the first coordinate and the second coordinate.

16. The apparatus of claim 11, wherein the second searching unit sets a type of the target content and determines the target content, based on the set type.

17. The apparatus of claim 11, wherein the searching unit determines the target content, based on content preference information, if a number of content items that matches the information indicated by the first coordinate and the information indicated by the second coordinate is at least two.

18. The apparatus of claim 11, wherein the controller controls the displaying unit to display content items that match the information indicated by the second coordinate along the first coordinate axis at positions corresponding to first coordinates.

19. The apparatus of claim 11, wherein the controller controls the displaying unit to display content items that match the information indicated by the first coordinate along the second coordinate axis at positions corresponding to second coordinates.

20. The apparatus of claim 11, wherein the first coordinate indicates time information, and the second coordinate indicates position information.

21. A non-transitory computer-readable recording medium having recorded thereon a program which, when executed by a computer, causes the computer to execute a method for displaying data, the method comprising:
searching for target content that matches information indicated by a first coordinate on a first coordinate axis and information indicated by a second coordinate on a second coordinate axis; and
displaying the target content at a position corresponding to the first coordinate and the second coordinate.

22. An apparatus comprising:
a first searching unit which discovers a first content item that matches information indicated by a first coordinate on a first coordinate axis based on a first search command;
a second searching unit which discovers a second content item that matches the information indicated by a second coordinate on a second coordinate axis based on a second search command related to the discovered first content item; and
a controller which displays the discovered first and second content items at positions corresponding to the first coordinate and the second coordinate, respectively.

23. The apparatus of claim 22, wherein the first content item comprises a plurality of images each corresponding to a respective point in time and the images are displayed along the first coordinate axis at the positions of the first coordinates which indicate the respective points in time on the first coordinate axis in chronological order.

24. The apparatus of claim 23, wherein:
the second coordinate axis corresponds to positional information in relation to the first content items, and
the second content item comprises a plurality of second content items discovered based on the second search command related to the first content items and displayed at the positions which correspond to the second coordinates along the first coordinate axis and the respective points in time along the second coordinate axis.

25. The apparatus of claim 23, wherein:
the second coordinate axis corresponds to objects related to a user who generated the first content items, and
the second content item comprises a plurality of second content items discovered based on the second search command related to the first content items and displayed at the positions which correspond to the second coordinates along the first coordinate axis and the respective points in time along the second coordinate axis.
